(19) United States
(12) Patent Application Publication
(10) Pub. No.: US 2022/0250618 A1
(43) Pub. Date: Aug. 11, 2022

(54) Suppression of LDW/LKA Prior to Tight Cornering of a Commercial Vehicle

(71) Applicant: Bendix Commercial Vehicle Systems LLC, Elyria, OH (US)

(72) Inventor: Thomas S. MILLER, JR., Lagrange, OH (US)

(21) Appl. No.: 17/168,320

(22) Filed: Feb. 5, 2021

(51) Int. Cl. B60W 30/12

(52) U.S. Cl. CPC B60W 30/12; B60W 2420/42; B60W 2300/145; B60W 2520/22

(57) ABSTRACT

A vehicle lane management system and a method of operating a vehicle lane management system is provided. The lane management system minimizes unnecessary driver warnings regarding lane departure and/or vehicle operation intervention actions to alter lane position when a vehicle is to be operated in a turn in conditions where the driver is or will be intentionally placing wheels of the vehicle outside of lane boundaries. The conditions for suppressing lane departure warnings and/or interventions include a vehicle speed being below a threshold speed and an upcoming turn radius being below a predetermined minimum turn radius.

### BACKGROUND AND SUMMARY OF THE INVENTION

The present invention relates to driver assistance systems, and in particular to lane departure warning and lane keeping assist systems for commercial vehicles such as tractor-trailer trucks, box trucks, buses, and the like.

Lane departure warning and lane keeping assist systems (hereinafter LDW/LKA systems) on commercial vehicles provide warnings to the vehicle driver of the incipient and/or actual excursions from the driving lane in which the vehicle is currently operating. Typically, such systems use a plurality of sensors such as cameras and control electronics to determine whether the vehicle is about to, or has, crossed a lane boundary, such as a pavement stripe. In the case of LDW systems, the control electronics prompt a visual, sound and/or haptic output to inform the driver of imminent or actual movement out of the driving lane. Lane keeping assist systems similarly use such sensors and control electronics, but in addition to providing an output to the driver, may also actively steer or otherwise intervene in the vehicle operation to return the vehicle to its driving lane. The outputs from these systems are typically only suppressed in particular circumstances, such as when the driver activates a turn signal when the vehicle is moving at lower speed, e.g., below 25 mph.

Commercial vehicles are, in general, wider and longer than passenger cars. This makes driving a commercial vehicle more difficult and the driver may be required to drive the vehicle slightly over lane lines in order to properly and safely navigate a tight corner or a narrow, curvy section of road. Currently, lane management systems, aka LDW/LKA systems, do not take into account what is required for a commercial vehicle to navigate corners and may intervene unnecessarily. For example, when a commercial vehicle comprising a 6×4 tractor and a standard 53 foot trailer attempts to negotiate a tight left turn, a driver will typically “set up” the turn by driving the vehicle at the right edge of the lane, and often over the right side lane line, to ensure the trailer's wheels will not contact objects on the inside of the turn. Similar, when entering or during travel through a left-hand curve on a narrow road, the driver may drive the vehicle at or over the right side lane line to ensure that the trailer's rear wheels do not cross over the center line into the oncoming traffic lane in the middle of the turn. In such situations LDW/LKA systems may intervene, outputting signals and/or attempting to alter the vehicle's travel path, despite the lane excursion to the right being a deliberate act to manage the trailer's movement during the turn. Drivers find these interventions during intentional maneuvers to be unnecessary and annoying.

An example of a commercial vehicle system with lane maintenance features installed is a vehicle equipped with Bendix® Wingman Fusion® systems. These systems include brake controller and camera systems having a variety of stored vehicle parameters, including basic information on the tractor (“power unit”) e.g., wheelbase, track width, towing capability, etc., information associated with the trailer (“towed unit), and information concerning the trailer, e.g., a towed load estimate (for example, trailer mass inferred by acceleration and/or braking sensors on the tractor and/or trailer, or provided to the tractor's electronic control units by a trailer's ECU via a Tractor Trailer communications link, such as the PLC connection commonly used in North America), trailer length, axle location, load sensor output signals, etc. In addition, the vehicle's electronic control units may also have the capability to calculate expected vehicle motion around a turn, taking into account parameters such as steering angle sensor information, tractor wheelbase, hitch location relative to the tractor and/or the trailer (i.e., the location of the pivot point of the trailer relative to the tractor), vehicle speed, etc. The vehicle's camera system may also be capable of determining the curvature of the upcoming turn by performing computational processing of the camera system images using a mathematical technique, such as using a third-order polynomial estimation technique (e.g., (Y=A0+A1*X+A2*X²+A3*X³), where Y is the lateral offset position from the vehicle centerline, and X is the longitudinal position from the vehicle). For example, with the current camera categorizing a lane line, the system would model that lane line with the third order polynomial where X is the longitudinal position from the truck, and the resulting Y would be lateral location of the lane line at that “X” position.

In the present invention, the vehicle's camera system images and other vehicle parameters such as steering angle, wheelbase and track width are processed to predict the vehicle's path, and an assessment is made where each set of vehicle's wheels are expected to travel relative to the predicted path, in order to identify any wheels that may depart from the lane, for example due to “off-tracking” of rear inside wheels. Off-tracking is a well-known phenomenon that is a function of the vehicle geometry. While the travel path of all of the vehicle wheels is about a central point, the tractor's rear wheels and the trailer's wheels rolling about different radii relative to the central point than the steering axle wheels, i.e., these following wheels track farther to the inside of the turn than the tractor's steering axle wheels, with the radii about the central point typically decreasing the farther the wheels are behind the steering axis wheels. For the entire vehicle, off-tracking is the difference between the turn radius of the vehicle's inside steering wheel and the smaller turn radius of the vehicle's rear-most axle.

In one embodiment of the present invention, determination of whether off-tracking is likely to occur may be based on the width of the lane ahead as determined from the vehicle camera system, the vehicle's predicted path based on the stored and sensed vehicle information (e.g., wheelbase, track-width information, speed, yaw, camera imaging, etc.). From such parameters an assessment one or more of the following sets of wheels' travel path, i.e., making a prediction of the radius of curvature the non-steering wheels will follow (geometry requires the following wheel radii to be inherently smaller than the curvature radius followed by the steering axle wheels, assuming the non-steering wheels are not sliding). The predicted following wheel curvature radii may then be used determine the amount of off-tracking that may occur at the following wheels. If the calculated minimum radius of curvature of the path of at least one of vehicle's wheel ends are less than the minimum radius of curvature of the forward road lane markers then it is likely the driver will need to setup the vehicle to safety navigate the curve.

The calculated amount of off-tracking may then be compared to a predetermined parameter such as a minimum radius and/or a maximum amount of off-tracking. If the determined curvature exceeds the predetermined or situation-dependent threshold, the LDW/LKA system may be instructed to suppress its outputs, so that the driver is not given unnecessary warnings or lane keeping assistance in a situation where the driver is likely guiding the vehicle tractor to the outside of the curve. Optionally, the driver may be provided with a visual indication such as a light on the instrument panel that indicates that the LDW/LKA system is currently being suppressed.

Among the advantages of the present invention is that because drivers will not receive as many unnecessary LDW notifications, they therefore will be more likely to react to unexpected lane departure warnings notifications when they do occur. The suppression of lane keeping assist in situations when the driver is knowing operating the vehicle to minimize off-tracking in tight curves, also minimizes the potential for a LKA to unnecessarily interfere with an intentional lane excursion by attempting to counter the driver's steering inputs.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of a commercial vehicle.

FIG. 2A is a schematic illustration of the commercial vehicle of FIG. 1 approaching a turn.

FIGS. 2B is schematic illustration of the commercial vehicle of FIG. 1 in a turn.

FIG. 3 is a flow chart of processing logic of an embodiment of the present invention.

Common reference label numbers are used with common features in the figures.

### DETAILED DESCRIPTION OF THE DRAWINGS

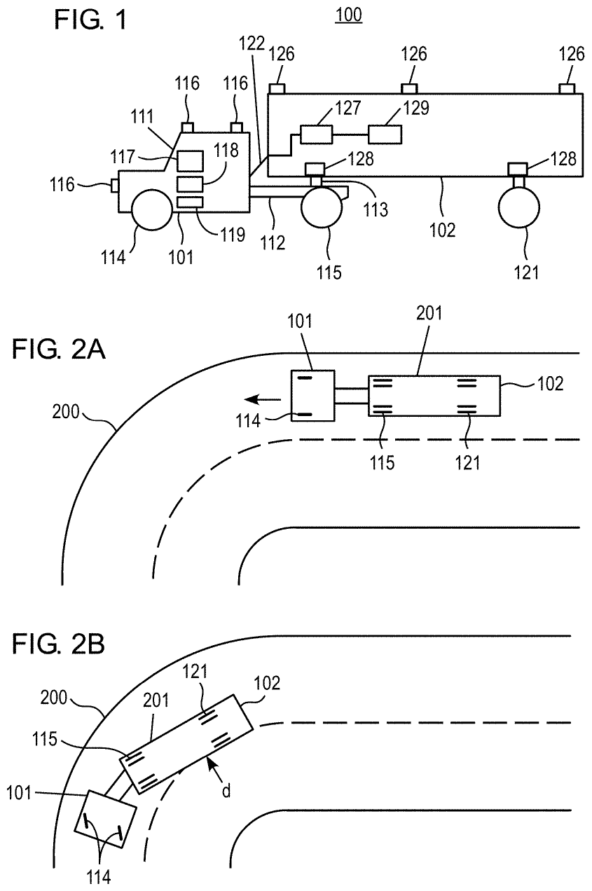

FIG. 1 shown a schematic elevation view of a commercial vehicle 100 having a tractor 101 and a trailer 102. The tractor 101 includes a cab portion 111, a frame portion 112 supporting a towing connection 113, steering axle wheels 114 and traction axle wheel 115. In this embodiment the tractor is equipped with sensors 116 (optical, radar, etc.), and a plurality of electronic control units, including a camera controller 117 configured to receive and process signals from the cameras 116, a brake controller 118 configured to, among other functions, determine vehicle mass based on vehicle acceleration and/or deceleration behavior, and a lane departure warning and/or lane keeping assist controller 119. The present invention is not limited to the specific control units identified in this embodiment. The functions performed by the controllers 117, 118 may be performed in other vehicle control units, and/or integrated with other control units, such as a power train controller controlling engine and transmission functions.

The trailer 102 is connected to the tractor 101 at the towing connection 113, and pivots relative to the tractor about pivot point 201 (see FIG. 2A). A person familiar with commercial vehicles such as Class 8 trucks will recognize that typically the pivot point, i.e., the tractor's hitch plate, is located over its rear axles.

The trailer 102 is supported on trailer wheels 121, and in this embodiment is also equipped with cameras and/or radar units 126 whose signals are transferred to the tractor via umbilical cable 122. The trailer 102 has a trailer controller 127 which receives signals from sensors such as load sensors 128 and accelerometers 129. The trailer controller 127 in this embodiment has the ability to share trailer information with one or more of the tractor controllers 117, 118, 119, and to respond to instructions from the tractor, for example to manage actuation of the trailer brakes in response to commands from brake controller 118. The present invention does not require the presence of a trailer controller or the above-mentioned sensors, as trailer-related information may be provided to the tractor's controllers in other ways, such as using the vehicle's acceleration and/or deceleration response to determine trailer loading, and manual data entry. The present invention further does not require the use of a wired connection between the trailer and the tractor, as communications may be conducted wirelessly. The principles of the present invention may also be applied to vehicles having more than one trailer in the vehicle train.

FIG. 2A is a schematic overhead view of the commercial vehicle 100 of FIG. 1 approaching a left-hand turn 200. At this stage, the cameras and other sensors of the vehicle's LDW/LKA system 119 are monitoring the vehicle's position relative to the lane markings and outer edge of the road. Because the vehicle is centered in its lane, no lane keeping or departure outputs to the driver are being generated.

FIG. 2B is a schematic view of the positioning of the tractor 101 and trailer 102 in the turn 200 that may occur if the driver steers the vehicle to maintain its position in the center of the lane during the turn. In this case, the wheels 114 of the steering axle remain near the center of the lane, but due to vehicle geometry the trailer axle wheels 121 undesirably enter the adjacent lane by a distance d (i.e., off-tracking). Off-tracking may be minimized by the driver when approaching the turn in FIG. 2A by driving with the right wheel of the steering axle wheels 114 at or over the outside lane boundary when entering the turn, but the driver can expect to be distracted and/or annoyed by LDW/LKA system 119 alerts and/or interventions.

In the present invention, in the course of continuous monitoring of the vehicle surroundings the LDW/LKA system 119 assesses whether the anticipated vehicle travel path includes an upcoming turn, determines whether the turn radius is below a predetermined threshold, i.e., a threshold below which it may be anticipated that the driver may pre-position the vehicle toward the outside of a turn on minimize off-tracking), and determines whether a warning to the driver and/or an intervention action is needed. The turn radius threshold may be variable, based on parameters such as vehicle speed, lane width, etc. If it is determined that the current operating conditions are such that a LDW/LKA output to the driver is unnecessary (for example, speed relatively slow or turn radius being so small that off-tracking is unavoidable), the LDW/LKA system 119 may suppress the output.

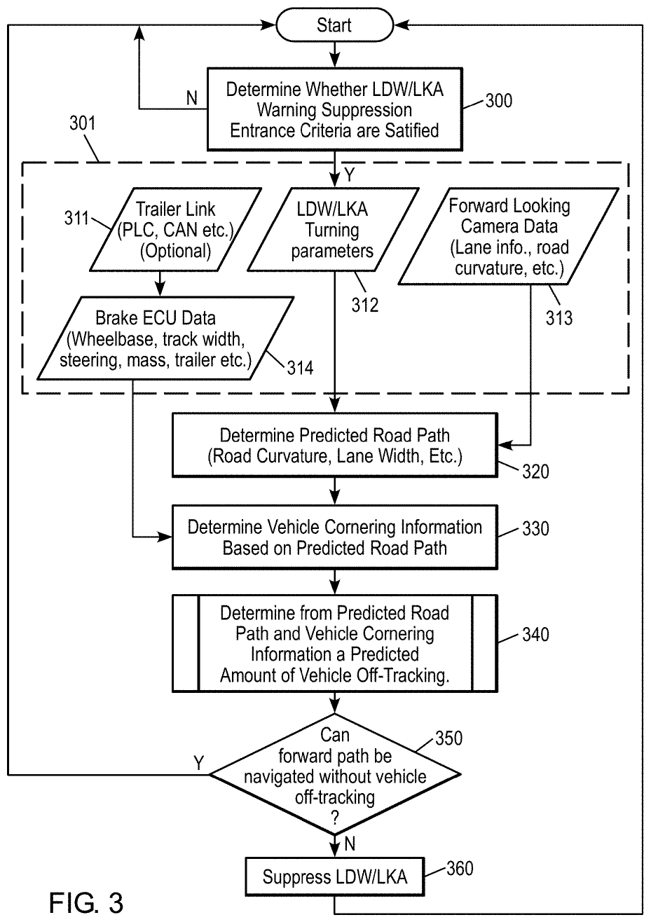

An example of such an LDW/LKA processing logic is shown in FIG. 3. The FIG. 3 flow-chart shows a simplified embodiment of the present invention in which in step 300 the system determines whether the criteria for entering the LDW/LKA suppression routine is satisfied. These criteria may include, for example, a minimum speed threshold above which it is unlikely that a deliberate lane departure would be expected. If the LDW/LKA suppression routine entry criteria are not satisfied, LDW/LKA system warnings remain active and control reverts to the start of the routine.

If the entry criteria are met, in step 301 the vehicle system obtain data from vehicle, environment and stored parameters, including data 311 made available from a trailer communications link if available, lane departure and/or lane keeping system parameters 312 (such as pre-stored data regarding the configuration of the vehicle), camera data 313 (such as images of the vehicle surroundings, including at least a view of the road in the travel direction of the vehicle), and vehicle data 314, in this embodiment obtained from an electronic brake controller (such as vehicle speed, yaw rate, braking system status, wheelbase, steering angle, vehicle masses, etc.). In step 320 the system in this embodiment uses the stored data 312 and environment data 313 to determine whether an upcoming turn is present in the travel direction, and preferably the upcoming lane width. In step 330 the system uses the stored and/or sensed vehicle-related data 311 and 314 (including vehicle parameters such as vehicle width and geometry (i.e., tractor wheelbase, trailer distance between trailer wheels and hitch pivot point, etc.)) to determine the predicted path of the vehicle along the predicted road path determined in step 320. In step 340 a determination is made as to whether the predicted path of the vehicle along the predicted road path may result in a lane departure/off-tracking event during the upcoming turn. In step 350, if the result of the determination in step 340 is that the forward path cannot be negotiated by the vehicle without off-tracking, control shifts to step 360, in which generation of lane departure warning and/or an intervention output from the LDW/LKA system is suppressed. Otherwise, control reverts to the beginning of the routine.

The foregoing discusses the present invention in the context of a vehicle and/or trailer having multiple separate controllers for different functions. This is not a requirement of the present invention. Rather, the functions of these controllers may be integrated into fewer controllers or even combined into a single controller. Nor is the present invention limited to data being obtained from specific controllers, where the desired data may be obtained from other controllers.

In another embodiment of the present invention, the LDW/LKA system 119 may continuously monitor the vehicle's environment, assessing whether on any turn there is the potential for an off-tracking event.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

### LISTING OF REFERENCE LABELS

100 vehicle
101 tractor
102 trailer
111 tractor cab portion
112 tractor frame portion
113 towing connection
114 steering axle wheels
115 traction axle wheels
116 cameras
117 camera controller
118 brake controller
119 LDW/LKA controller
121 trailer axle wheels
122 trailer umbilical cable
126 trailer camera and/or radar units
127 trailer controller
128 trailer load sensors
129 trailer accelerometer
201 pivot point

What is claimed is:

1. A vehicle lane management system, comprising:
a plurality of vehicle-mounted sensors arranged to sense an environment outside of the vehicle at least in a travel direction of the vehicle;
a lane positioning controller configured to
receive environment information from the plurality of vehicle sensors,
determine a lane position of the vehicle and whether there is a turn ahead in the travel direction of the vehicle based on the received environment information,
determine, based on the determined lane position and turn presence, or based on the determined lane position, turn presence, and additional vehicle information based one or both of vehicle sensors and stored vehicle information, whether a wheel of the vehicle is, or is projected to, depart from the vehicle lane during the turn, and
determine, based on the additional vehicle information, whether a vehicle operating parameter limit is outside a predetermined range, and
suppress a lane management output if the vehicle operating parameter is outside of the predetermined range.

2. The vehicle lane management system of claim 1, wherein
the predetermined range is variable, based on vehicle speed, lane width, turn radius or vehicle geometry or a combination of one or more of vehicle speed, lane width, turn radius, and vehicle geometry.

3. The vehicle lane management system of claim 1, wherein
the vehicle is a commercial vehicle having a tractor in tandem with a trailer connected via a pivoting connection, and
the received environment information includes information from sensors on the trailer.

4. The vehicle lane management system of claim 3, wherein
the vehicle sensors include tractor sensors and trailer sensors, and
the additional vehicle information includes
tractor information based one or both of tractor sensors and stored trailer information, and
trailer information based one or both of trailer sensors and stored trailer information.

5. The vehicle lane management system of claim 4, wherein
the tractor information includes tractor geometry information including distance between a tractor steering axle and a tractor traction axle, a distance between the pivoting connection and the tractor traction axle, and a distance between the pivoting connection and a trailer axle.

6. The vehicle lane management system of claim 3, wherein
the plurality of vehicle-mounted sensors includes tractor sensors and trailer sensors, and
the tractor sensors and the trailer sensors include environment monitoring cameras.

7. The vehicle lane management system of claim 6, wherein
the lane positioning controller includes a camera system image processing controller configured to process the received environmental information

8. A method of operation of a lane management system including a plurality of vehicle-mounted sensors arranged to sense an environment outside of the vehicle at least in a travel direction of the vehicle and a lane positioning controller, comprising the acts of:
receiving at the lane positioning controller environment information from the plurality of vehicle sensors,
determining using the lane positioning controller a lane position of the vehicle and whether there is a turn ahead in the travel direction of the vehicle based on the received environment information,
determining using the lane positioning controller, based on the determined lane position and turn presence, or based on the determined lane position, turn presence, and additional vehicle information based one or both of vehicle sensors and stored vehicle information, whether a wheel of the vehicle is, or is projected to, depart from the vehicle lane during the turn, and
determining, using the lane positioning controller whether a vehicle operating parameter limit is outside a predetermined range, based on the additional vehicle information, and
suppressing a lane management output if the vehicle operating parameter is outside of the predetermined range.
